(19) United States
(12) Patent Application Publication
(10) Pub. No.: US 2014/0330664 A1
(43) Pub. Date: Nov. 6, 2014

(54) SYSTEM AND METHOD FOR CONDUCTING AN ELECTRONIC LAND AUCTION

(71) Applicant: Renterra Farmland Sales and Rental Auction Inc., Regina (CA)

(72) Inventor: Lyndon Dwayne Lisitza, Regina (CA)

(73) Assignee: Renterra Farmland Sales and Rental Auction Inc., Regina (CA)

(21) Appl. No.: 14/267,359

(22) Filed: May 1, 2014

Related U.S. Application Data
(60) Provisional application No. 61/818,069, filed on May 1, 2013.

(51) Int. Cl. G06Q 50/16; G06Q 30/08

(52) U.S. Cl. CPC G06Q 50/165; G06Q 30/08
USPC 705/26.3

(57) ABSTRACT

Some embodiments of the present disclosure relate to a method of conducting an electronic auction. The method may include: identifying a plurality of land listings that each correspond to a parcel of land that is available for auction; identifying the parcel of land of one land listing of the plurality of land listings; providing an electronic auction for the identified parcel of land; determining, using one or more of the plurality of land listings, an additional parcel of land that is available for auction, the additional parcel of land being spatially proximate to the identified parcel of land; and providing a user interface for displaying the identified parcel of land, displaying a physical position of the identified parcel of land relative to the additional parcel of land, and receiving bid inputs for the electronic auction.

### FIELD

The described embodiments relate generally to electronic auction systems, and in particular, to systems and methods of conducting an electronic auction for farm land.

### INTRODUCTION

Landowners having farm land available for sale or rent typically have difficulty finding farmers who desire to buy or rent their land. For example, traditional methods for a landowner to advertise their land may involve word-of-mouth or print communications. Such methods are economically inefficient, and may not result in the optimal price for selling or renting the land. Moreover, potential buyers or renters do not have an easy way to discover what parcels of land are available for sale or rent.

There is thus a need for improved systems and methods of providing auctions for farm lands.

### SUMMARY

In one aspect, some embodiments of the present disclosure relate to a method of conducting an electronic auction. The method may include: identifying a plurality of land listings, each of the plurality of land listings corresponding to a parcel of land that is available for auction; identifying the parcel of land of one land listing of the plurality of land listings; providing an electronic auction for the identified parcel of land; determining, using one or more of the plurality of land listings, an additional parcel of land that is available for auction, the additional parcel of land being spatially proximate to the identified parcel of land; and providing a user interface for displaying the identified parcel of land, displaying a physical position of the identified parcel of land relative to the additional parcel of land, and receiving bid inputs for the electronic auction.

In some embodiments, the user interface is also configured for displaying the additional parcel of land. In some embodiments, the user interface includes a map that displays the physical position of the identified parcel of land relative to the additional parcel of land. In various embodiments, the map displays the identified parcel of land as being adjacent to the additional parcel of land. In some embodiments, the plurality of additional parcels of land are connected to each other, and the identified parcel of land completes a block of land that includes the identified parcel of land and the plurality of additional parcels of land.

In some embodiments, the method(s) of the present disclosure may include determining a plurality of additional parcels of land that are available for auction, and each of the plurality of additional parcels of land may be spatially proximate to the identified parcel of land. In such embodiments, the user interface may display the physical position of the identified parcel of land relative to each of the plurality of additional parcels of land.

In some embodiments, at least one of the plurality of land listings comprise Geographical Information Systems (GIS) data.

In some embodiments, the user interface is configured to display, for the identified parcel of land, data selected from a group consisting of: crop input information, a soil class, a land assessment report, and a legal land description.

In some embodiments, the identified parcel of land is identifiable using a land identifier from a land survey.

In some embodiments, the electronic auction is associated with conditions governing use of the identified parcel of land.

In some embodiments, prior to displaying the identified parcel of land, the user interface is further configured for receiving input identifying a home location of a potential bidder in the electronic auction, and receiving input indicating a criteria relating to the home location. The identified parcel of land that is displayed on the user interface can satisfy the criteria. In some embodiments, the criteria may be a maximum acceptable distance from the home location.

In some embodiments, the electronic auction is not initiated until a reserve price for the identified parcel of land is reached. After the electronic auction is initiated, the electronic auction may be set to end after a predetermined period of time. Additionally or alternatively, the electronic auction may not end until a period of time after a final bid is made.

In some embodiments, the bid inputs for the electronic auction may include a portion of crops producible by the identified parcel of land. In some embodiments, the identified parcel of land comprises pasture land, and the bid inputs comprise a value per each animal that can be grazed on the pasture land.

In another aspect, some embodiments of the present disclosure relate to a server device comprising a processor and a memory storing instructions which, when executed by the processor, cause the processor to: identify a plurality of land listings, each of the plurality of land listings corresponding to a parcel of land that is available for auction; identify the parcel of land of one land listing of the plurality of land listings; provide an electronic auction for the identified parcel of land; determine, using one or more of the plurality of land listings, an additional parcel of land that is available for auction, the additional parcel of land being spatially proximate to the identified parcel of land; and provide a user interface for displaying the identified parcel of land, displaying a physical position of the identified parcel of land relative to the additional parcel of land, and receiving bid inputs for the electronic auction.

In various embodiments, the server device may be configured to perform various steps of the methods described herein.

In another aspect, some embodiments of the present disclosure relate to a computer readable medium storing instructions which, when executed by a processor of a computing device, cause the processor to: identify a plurality of land listings, each of the plurality of land listings corresponding to a parcel of land that is available for auction; identify the parcel of land of one land listing of the plurality of land listings; provide an electronic auction for the identified parcel of land; determine, using one or more of the plurality of land listings, an additional parcel of land that is available for auction, the additional parcel of land being spatially proximate to the identified parcel of land; and provide a user interface for displaying the identified parcel of land, displaying a physical position of the identified parcel of land relative to the additional parcel of land, and receiving bid inputs for the electronic auction.

In various embodiments, the computer readable medium may store instructions for performing various steps of the methods described herein.

### DRAWINGS

For a better understanding of embodiments of the systems and methods described herein, and to show more clearly how they may be carried into effect, reference will be made, by way of example, to the accompanying drawings in which:

FIG. 1 is a block diagram of a system for conducting an electronic land auction, in accordance with at least one embodiment;

FIG. 2 is a flowchart diagram illustrating the steps of a method of conducting an electronic land auction, in accordance with at least one embodiment;

FIG. 3 is a screenshot of an example user interface for viewing available land auctions, in accordance with at least one embodiment;

FIG. 4 is a screenshot of an example user interface for entering information into a bidder profile, in accordance with at least one embodiment;

FIG. 5 is a screenshot of an example user interface for creating a land listing, in accordance with at least one embodiment;

FIG. 6 is a screenshot of an example user interface for creating an electronic auction, in accordance with at least one embodiment;

FIG. 7 is a flowchart diagram illustrating the steps of a method of providing a land auction, in accordance with another example embodiment; and

FIGS. 8 and 9 are screenshots of example user interfaces for viewing available land auctions, in accordance with other example embodiments.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The embodiments of the systems and methods described herein may be implemented in hardware or software, or a combination of both. However, these embodiments may be implemented in computer programs executing on programmable computers, each computer including at least one processor, a data storage system (including volatile and non-volatile memory and/or storage elements), and at least one communication interface. For example, the programmable computers may be a server, network appliance, set-top box, embedded device, computer expansion module, personal computer, laptop, personal data assistant, or mobile device. Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

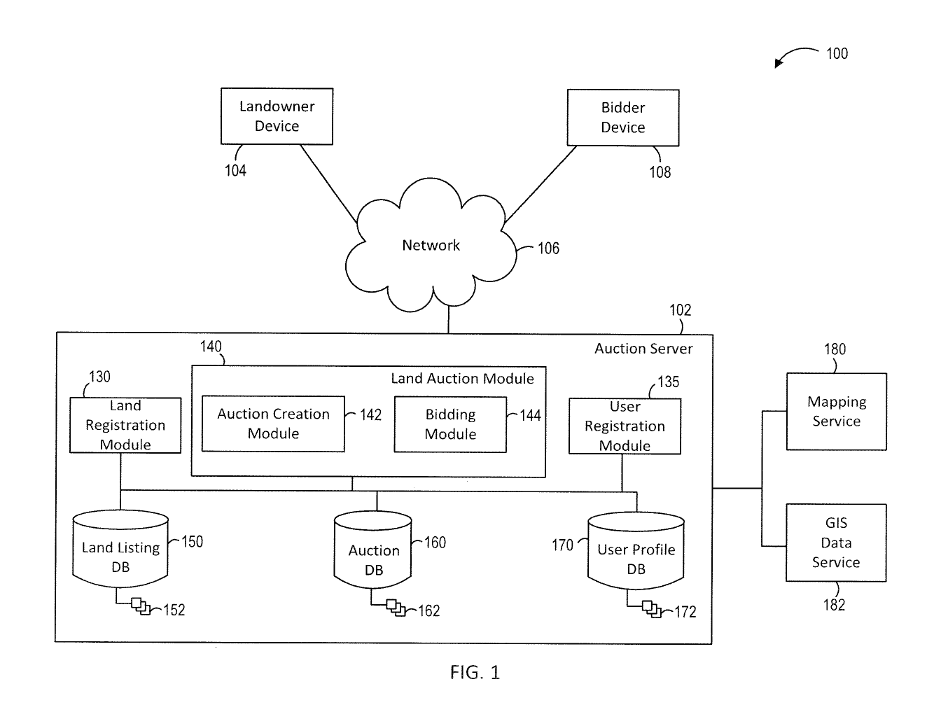

Referring to FIG. 1, shown there generally as 100 is a block diagram of a system for providing a land auction, in accordance with at least one embodiment of the present disclosure. The system 100 may include, for example, but not limited to, an auction server 102, a landowner device 104, and a bidder device 108, all communicably connected via network 106.

From a high-level perspective, the auction server 102 may perform various acts described herein to allow landowners (using the landowner device 104) to register parcels of land. Once registered, the auction server 102 may also perform acts to allow landowners to create an electronic auction for a registered parcel of land to, for example, sell, rent, or lease the parcel of land. Potential purchasers, renters, or lessees (using the bidder device 108) may then view the parcels of land that are available in a user interface that shows the physical positions of the various parcels of land relative to each other. In this manner, the potential bidders may gain a better understanding of the value of a given parcel of land available and submit bids in the electronic auctions accordingly. For example, a potential renter may see that a given parcel of land is adjacent to another parcel of land, and submit bids in the electronic auctions for both parcels of land because they would like to farm both parcels of land together.

The example scenarios discussed herein will be with respect to parcels of land that are available for rent (and associated land rental auctions). In such scenarios, bidders are typically potential renters. However, it will be understood that the embodiments of the present disclosure may be used in other scenarios, such as, for example, with parcels of land that are available for sale and/or with parcels of land that are available for lease. In those scenarios, bidders may be potential buyers or potential lessees.

Generally, the auction server 102 may be any computing device (e.g., the programmable computers discussed above). For example, the auction server 102 may include one or more processors and one or more memories storing instructions for performing the various acts described herein as being performed by the auction server 102. The auction server 102 may also include a network interface that allows the auction server 102 to communicate with the landowner device 104 and the bidder device 108.

The landowner device 104 and/or the bidder device 108 may similarly be any suitable computing device (e.g., the programmable computers described above). In various embodiments, the landowner device 104 and/or the bidder device 108 may similarly include one or more processors and one or more memories storing instructions which, when executed, configure the one or more processors to communicate with the auction server 102.

In various embodiments, auction server 102 may be accessed via a website that is accessible by a web browser application (not shown) executable on the landowner device 104 and/or the bidder device 108. In such embodiments, the auction server 102 may also be provided with a web server application (not shown) that is configured to communicate with the web browser applications stored on the landowner device 104 and/or the bidder device 108. Additionally or alternatively, the auction server 102 may provide an Application Programming Interface (API) for accessing the functionality of the auction server 102. In such embodiments, a dedicated application on the landowner device 104 and/or the bidder device 108 may be configured to access the API when interacting with the auction server 102.

The various components of the auction server 102 will now be described. The auction server 102 may include various program modules configured to provide the functionality described herein. These program modules may include a land registration module 130, a user registration module 135, and a land auction module 140. The program modules may be configured to communicate (e.g., via a web server application) with the landowner device 104 and/or the bidder device 108. Also, as discussed below, the program modules may be configured to communicate internally with the land listing database 150, auction database 160 and user profile database 170 to store and retrieve data.

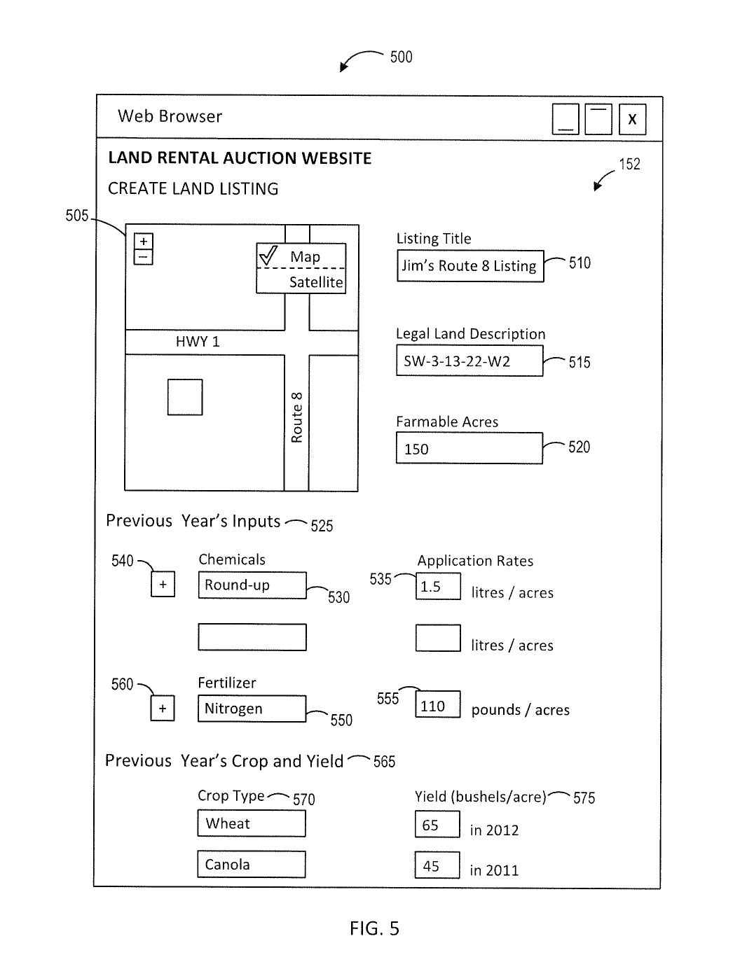

The land registration module 130 may perform various acts that allow the land owner device 104 to provide information relating to parcels of land that are available for auction. In operation, when a landowner (using a land owner device 104) attempts to register a parcel of land they have available for auction, the land registration module 130 may be configured to provide a user interface that allows the landowner to enter information about the parcel of land. A screenshot of such an example user interface is shown in FIG. 5, and will be discussed in greater detail below.

Once the information about the parcel of land is received by the land registration module 130, the land registration module 130 may create a land listing corresponding to the parcel of land for which information has been entered. The land listing 152 may be stored in the land listing database 150.

The land auction module 140 may be configured to perform actions generally relating to the functionality associated with providing electronic land auctions. In particular, the land auction module 140 may be organized as having two sub modules that each provide different functionality with respect to the land auctions: the auction creation module 142 allows for the creation of a land auctions, and the bidding module 144 provides functionality relating to the bidding process during a given land auction.

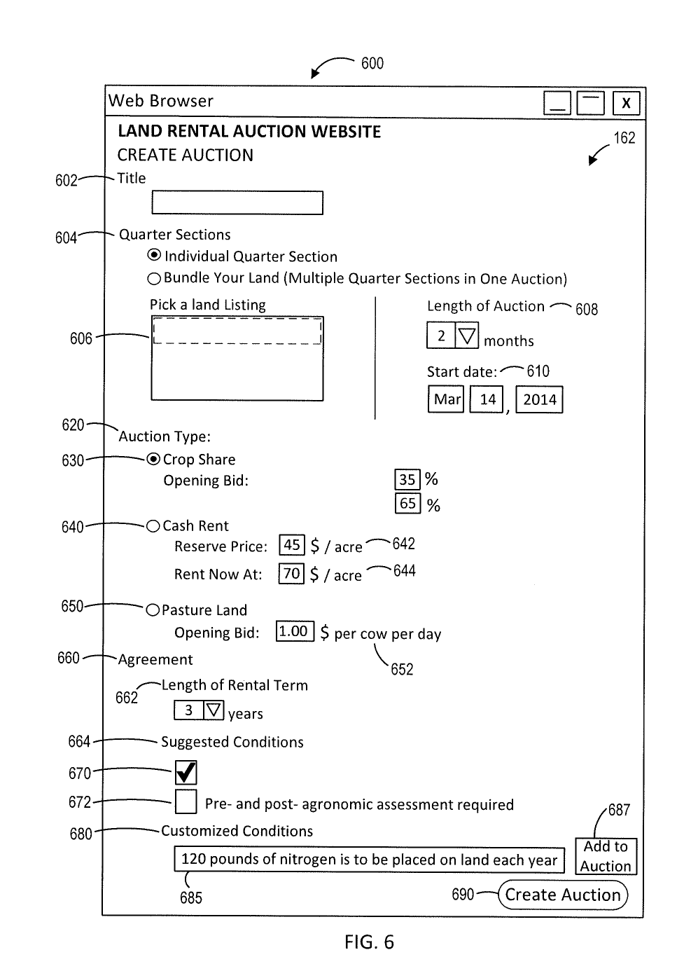

In operation, the auction creation module 142 may be configured to provide a user interface that receives information about a land auction that is to be created. A screenshot of such an example user interface is shown in FIG. 6, and will be discussed in greater detail below. Once the information about a land auction has been entered, the auction creation module 142 may store the information for the auction as auction data records 162 in the auction database 160. For ease of explanation, the term “auction” and “auction data records” will be used interchangeably herein.

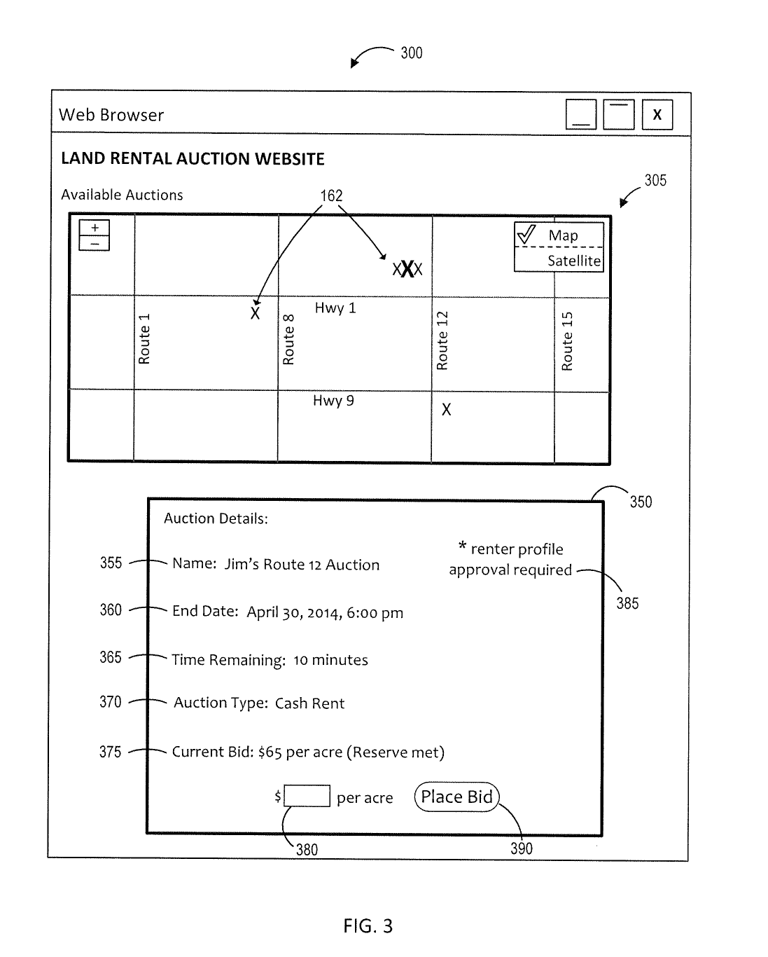

The bidding module 144 may be configured to provide a user interface that allows bidders to enter bids (using the bidder device 108) for land auctions 162 that have been created by landowners. The bidding module 144 may provide a user interface that displays the relative physical locations of parcels of land available for auction. Since parcels of land may be more valuable to bidders if they are adjacent to another parcel of land available for auction (of if they complete a larger block of land), such a user interface may enhance a potential bidder's ability to locate desirable land. A screenshot of such an example user interface is shown in FIG. 3, and will be discussed in greater detail below.

In various embodiments, the user interface for receiving bid inputs may include a map that illustrates the physical position of various parcels of land that are available for auction. The map may be provided by way of a plug-in or a widget on the user interface, and the plug-in or widget may connect to an external mapping service 180. The external mapping service 180 may provide an Application Programming Interface (API) that allows the plug-in to communicate with the mapping service 180, and to display the map. Examples of mapping services 180 include Google Maps™, Bing Maps™, and MapQuest™.

As discussed above, in various embodiments, when receiving input for creating a land listing, the land registration module 130 may be configured to identify parcels of land by legal land descriptions. For example, the legal land description may be in a format used by land surveys such as the Dominion Land Survey used in the provinces of Manitoba, Saskatchewan and Alberta in Canada, and/or the Public Land Survey System (PLSS) used in the United States. To convert the land descriptions into geographic coordinates (e.g., latitude and longitude) that can be received by the mapping service 180, the auction server 102 may communicate with a Geographic Information System (GIS) data service 182 that is capable of performing such conversion of legal land descriptions to geographic coordinates.

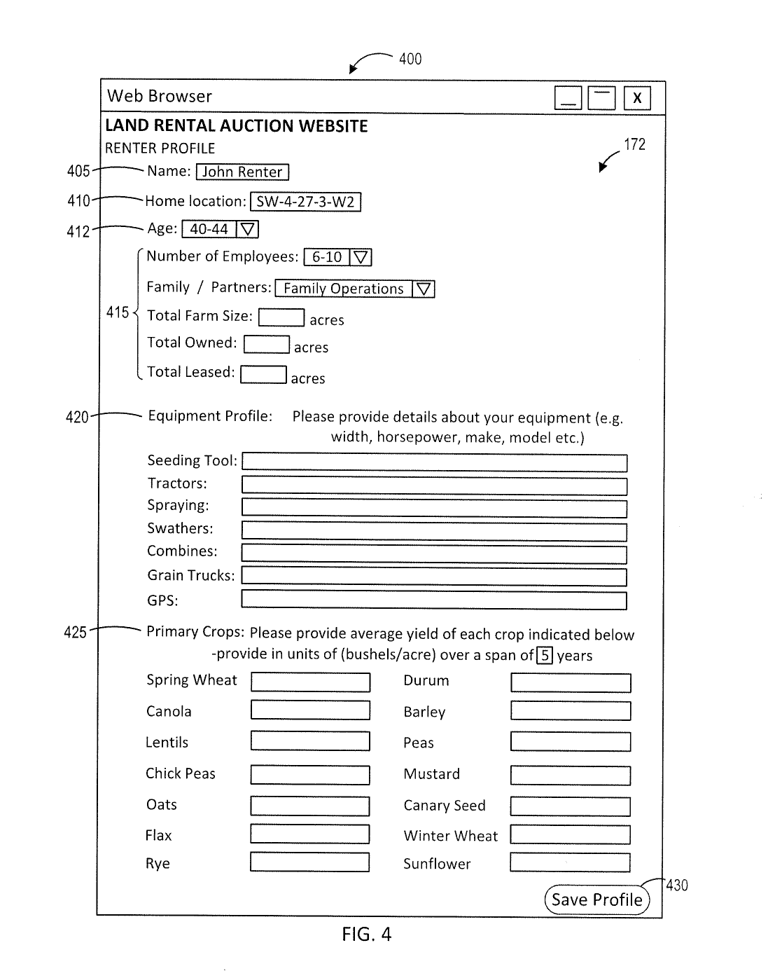

In various embodiments, the auction server 102 may also include a user registration module 135 that allows potential users of the auction server 102 to create an account and a user profile. For example, during the user registration process, the auction server 102 may receive input indicating the type of account that is desired to be created (e.g., a landowner account and/or a bidder account). If the user account is to be of a ‘bidder’ type (e.g., a ‘renter’ type), for example, the user registration module 135 may be configured to provide a user interface that receives various details about the bidder's farming operations. As discussed below, the land auctions may then be configured to indicate a condition that the landowner must approve a winning bidder's profile, prior to the transaction proceeding. A screenshot of an example user interface for creating a ‘renter’ profile is shown in FIG. 4, and will be discussed in greater detail below.

To store information about user profiles, the auction server 102 may be provided with a user profile database 170. For example, as illustrated, the bidder profiles 172 that can be generated by the user registration module 135 are illustrated as being stored in the user profile database 170.

Network 106 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

It will be understood that although only a single auction server 102 is shown in FIG. 1 for clarity, there may be multiple physical servers distributed over a wide geographic area and connected via network 106, for example. Similarly, although only one landowner device 104 and one bidder device 108 have been illustrated, any suitable number of landowner devices 104 or bidder devices 108 may connect to the auction server 102.

As well, although illustrated as being connected directly to the auction server 102, in various embodiments, the mapping service 180 and/or the GIS data service 182 may be connected to the network 106. In such embodiments, the auction server 102 may communicate with either the mapping service 180 or the GIS data service 182 through the network 106.

Further details about the various operation of the auction server 102 will now be discussed.

### Viewing Available Land Auctions

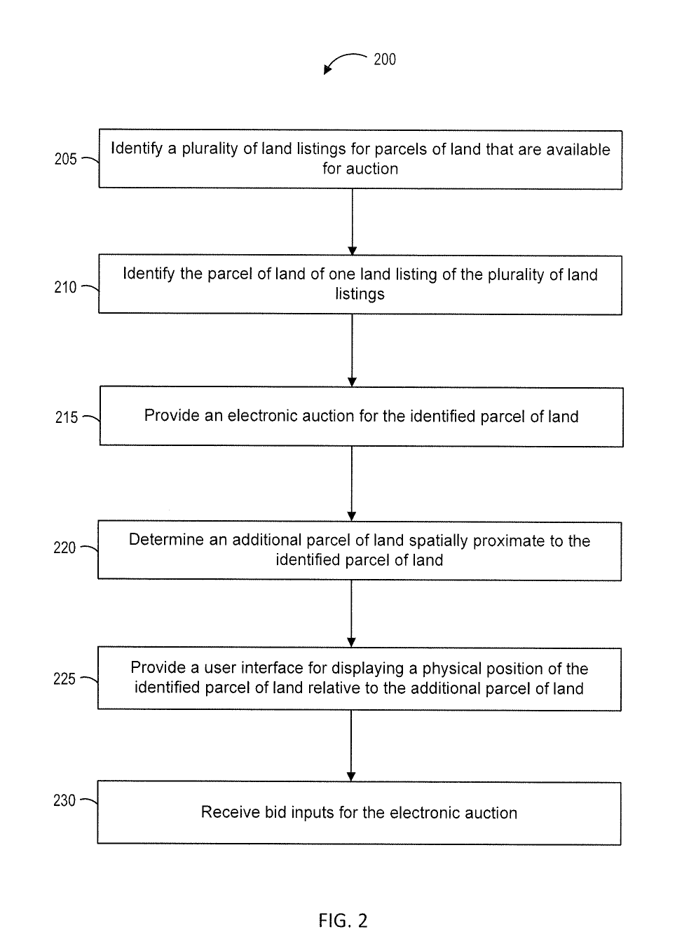

Referring to FIG. 2, shown there generally as 200 is a flowchart diagram for a method of conducting a land auction, in accordance with a least one embodiment. When discussing the steps of the method shown in FIG. 2, reference will simultaneously be made to the various components shown in FIG. 1, as well as the example user interface shown in FIG. 3.

At step 205, the auction server 102 may identify a plurality of land listings for parcels of land that are available for auction. For example, this may be performed by the bidding module 144 querying the auction database 160 to locate pending auctions 162. Having identified the suitable auctions 162 stored in the auction database 160, the bidding module 144 may proceed to identify the land listings 152 (stored in land listing database 150) that correspond to the land auctions 162.

At step 210, the bidding module 144 may identify the parcel of land one land listing of the plurality of land listings 152. For example, this may be performed by the bidding module 144 selecting one of the land listings 152 from the plurality of land listings identified in step 205, and identifying the particular land parcel specified by the legal land description stored in the land listing 152.

At step 215, an electronic auction may be provided for the parcel of land identified at step 210. This electronic auction may be the same electronic auction 162 that the land listing 152 is associated with (e.g., the same electronic auction that was located in step 205).

At step 220, the bidding module 144 may determine an additional parcel of land that is spatially proximate to the identified parcel of land. For example, this step may involve the bidding module 144 determining which of the land listings located at step 205 are physically located close to the parcel of land identified in step 210.

As noted earlier, the land listings may identify a given parcel of land according to a legal land description. However, the bidding module 144 may not be able to determine relative distances between parcels of land using the land descriptions alone. As such, in some embodiments, the bidding module may communicate with the GIS data service 182 to convert the legal land description to geographic coordinates (e.g., latitude and longitude). Using the geographical coordinates, the bidding module 144 may then be able to communicate with the mapping service 180 and/or the GIS data service 182 to calculate relative distances between any two given parcels of land.

Once determined, each of the relative distances between a given land listing 152 located at step 205 and the land listing identified in step 210 can be compared to a predetermined distance to determine if a given located land listing 152 is sufficient spatially proximate to the parcel of land identified in step 210. In various embodiments, this predetermined distance may be pre-defined or may be user-configurable.

At step 225, the bidding module 144 may provide a user interface for displaying a physical position of the identified parcel of land relative to the additional parcel of land. For example, the predetermined distance that determines whether a given land listing is sufficiently spatially proximate may be governed by a map plug-in provided on a user interface for searching available auctions, and whether the given land listing 152 can be shown on the map (e.g., if a given land listing can be shown on a map, it may be considered to be sufficiently proximate).

Referring simultaneously to FIG. 3, shown there generally as 300 is a screenshot of an example user interface that may be provided by the bidding module 144 at step 225 of FIG. 2. As illustrated, a web browser application (e.g., as may be executing on the bidder device 108) accesses a webpage provided by the auction server 102. For clarity of illustration, various aspects of the web browser application (e.g., an address bar and a menu bar) are omitted. As discussed above, the example scenarios described herein will generally relate to land rental auctions for auctioning off parcels of land that are available for rent.

The user interface 300 may contain a map 305 (e.g., as may be provided by way of a plug-in that communicates with the mapping service 180) that shows the physical locations of parcels of land available for rent. As shown, the example map illustrates a particular geographic area with routes 1, 8, 12, and 15 running north to south, and various highways 1 and 9 running east to west. As well, auctions 162 with for parcels of land with a geographic location that appears on the map are shown with an ‘X’.

The map 305 shows several auctions 162 for parcels of land with physical locations relative to each other. For example, there are three auctions 162 near the intersection of ‘Hwy 1’ and ‘Route 12’. There is also an auction 162 near the intersection of ‘Hwy 1’ and ‘Route 8’, as well as near the intersection of ‘Hwy 9’ and ‘Route 12’. By displaying the auctions 162 in the manner shown, bidders can be better informed about the relative geographic positions of the parcels of land that are available for rent.

For example, as shown, a bidder may be able to see that the parcel of land for a given auction 162 is adjacent to another parcel of land for another auction. With this information, a bidder may be able to monitor and bid on both auctions in an attempt to secure the land rental for both parcels of land. As well, a bidder may be able to see that there are auctions 162 for parcels of land that are connected to each other such that the parcel of land for a given land listing completes a block of land. As shown, the three auctions 162 at the intersection of ‘Hwy 1’ and ‘Route 12’ form a contiguous block of land that may be desirable for a potential bidder to farm on because they may be able to spend less time travelling between parcels of land.

Referring back to FIG. 2, at step 230, the bidding module 144 may receive bid inputs for an electronic auction. This may be performed through the user interface provided to a bidder device 108 that shows the available auctions. For example, referring again to FIG. 3, one of the auctions 162 shown in the map 305 may be selected, such that details of the auctions are shown to the bidder. As illustrated, one of the three land listings at the intersection of ‘Hwy 1’ and ‘Route 12’ are selected (as is indicated by way of one of the three ‘X’s being bolded and enlarged). When selected, details about the auction may be provided in the user interface. For example, an ‘Auction Details’ pane 350 may be shown to the user. The ‘Auction Details’ pane 350 may provide information such as the auction name 355 (e.g., ‘Jim's Route 12 Auction’), the ending date/time 360 of the auction (e.g., ‘Apr. 30, 2014, 6:00 pm’), and the remaining time 365 of the auction (e.g., ‘10 minutes’).

As will be described below, the land auction system of the present disclosure may be configured to provide auctions of different types, depending on what is selected when the auction 162 is created. The ‘Auction Details’ pane 350 may therefore also be configured to show the auction type 370 of the auction that is selected to be displayed. As shown, the auction type 370 is ‘Cash Rent’, which is a type of auction where the price of the auction is in units of dollars per acre of farmable land available in the auction. Based on the type of auction, the displayed information about the current bid and what a bid constitutes may vary. In the illustrated example, since the auction type 370 is ‘Cash Rent’, the current bid 375 is shown in units of dollars per acre (e.g., ‘$65 per acre’), and a bid input control 380 is provided that allows potential renters to enter the next bid in the electronic auction. Once a price is entered in the bid input control 380, the user interface may receive input confirming the placement of the bid via the ‘Place Bid’ control 390.

In various embodiments, the electronic auction may be configured to not be initiated until a reserve price for the identified parcel of land is reached. In such case, if the reserve has not been met, the user interface 300 may be able to receive bid inputs via the bid input control 380 and ‘Place Bid’ control 390, but the end date 360 and the time remaining 365 fields may indicate that the auction has not started. Once the reserve price is met, these fields may then be updated to indicate when the auction is ending and the time remaining in the auction.

Despite the auction details pane 350 indicating the end date 360 and the time remaining 365, in various embodiments, the electronic auction may be configured to not end until a predetermined period of time (e.g., an hour) after a final bid is made. In such case, if a bid input for an electronic auction is received within the purported last hour of the electronic auction, the end date/time 360 and the time remaining 365 for the auction can be reset to the full length of the predetermined period of time (e.g., one hour). Such resetting may ensure that at least the predetermined period of time elapses after the last bid input is received. This may reduce the possibility of a potential bidder “sniping” the auction (e.g., placing a higher bid than a current highest public bid at the last possible moment, and giving the other potential bidders no time to outbid the “sniper”).

The ‘Auction Details’ pane 350 may also be configured to display various conditions 385 that the landowner has indicated as being applicable for the given electronic auction 162. One such condition 385 may be that the landowner must give his/her approval of the bidder profile (e.g., a ‘renter’ profile) of the highest bidder before the rental transaction can proceed. As noted earlier, the bidder profile 172 may be stored in the user profile database 170 (as shown in FIG. 1) when a potential bidder registers for the land auction system.

### Creating a Bidder Profile

Referring to FIG. 4, shown there generally as 400 is a screenshot of an example user interface for entering information into a bidder profile 172 (e.g., a ‘renter’ profile), in accordance with at least one embodiment. For example, the user interface may be provided by the user registration module 135 shown in FIG. 1. As shown, the user interface 400 may be configured to receive the name 405 (e.g., ‘John Renter’), age range 412 (e.g., ‘40-44’), and details of the bidder's farming operations 415 such as: the number of employees the potential bidder may have, the nature of the potential bidder's business operations (e.g., family operations or corporate), the total farm size operated by the potential bidder, and the total number of acres owned/leased by the bidder.

Additionally or alternatively, the user interface may be provided with an equipment profile section 420 that is configured to receive input regarding the equipment used by the bidder. As shown, the user interface 400 may receive information about the ‘seeding tools’, ‘tractors’, or ‘grain trucks’ that a bidder has, for example. Moreover, the user interface 400 may be provided with a primary crops section 425 that receives input regarding the crop yields that the bidder has been able to achieve with their farming operations in the past. For example, as shown, the user interface may receive input for various crops such as ‘canola’, ‘barley’, or ‘sunflower’. Also, as shown, the user interface may be configurable with regard to the historical time range for which the bidder is entering their production values (e.g., five years).

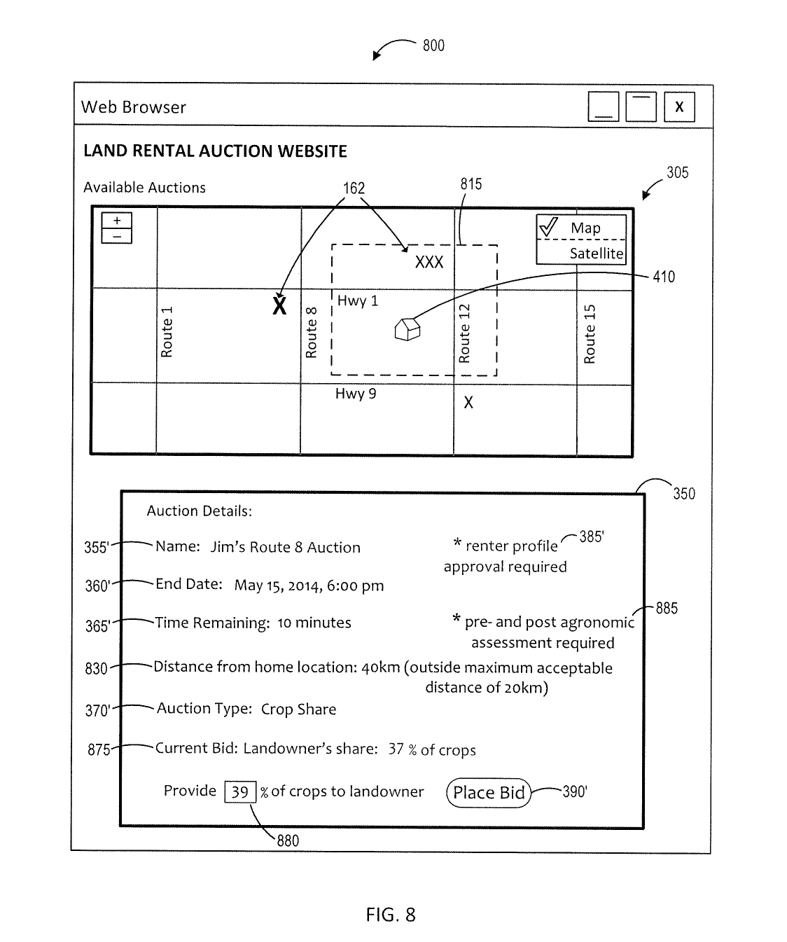

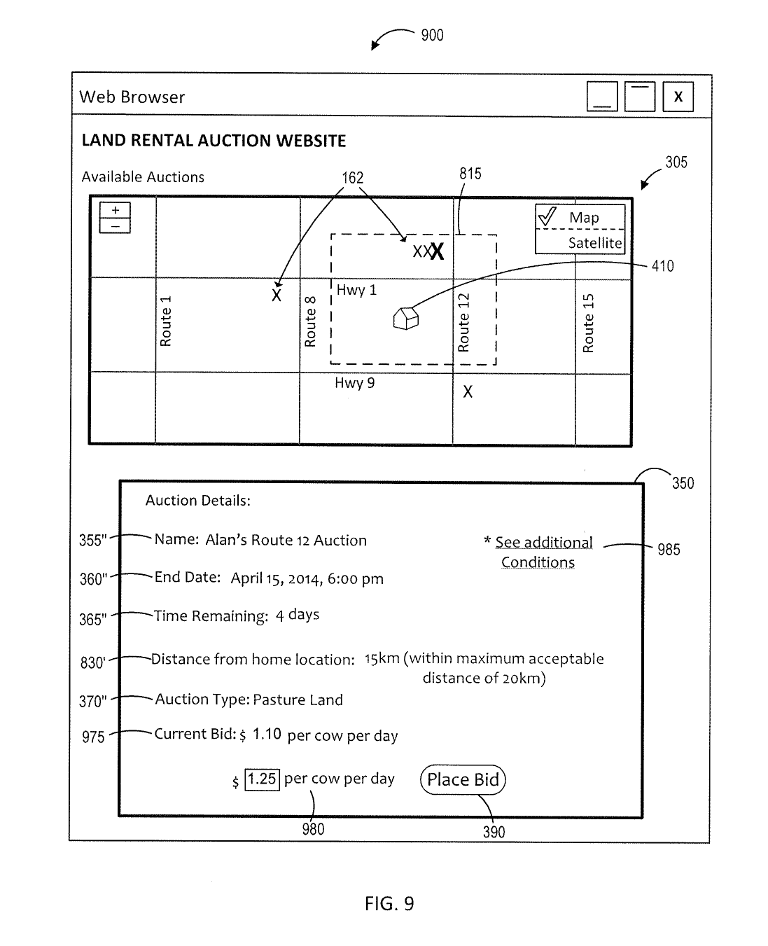

In various embodiments, the user interface 400 for entering a bidder profile 172 may include a field for receiving a home location 410 of the bidder. As discussed below, the home location may, in some embodiments, be shown on the user interface that displays the auctions that are available. Example user interfaces that show the physical location of the home location are shown in FIGS. 8 and 9, and will be discussed in greater detail below. As illustrated in FIG. 4, the home location is received in the form of a legal description according to the Dominion Land Survey used in certain provinces in Western Canada (e.g., ‘SW-4-27-3-W2’). According to the Dominion Land Survey, this would mean South West quarter of Section 4, Township 27, Range 3, West of the 2^{nd} Meridian. It will be understood that other formats of legal land descriptions (e.g., according to the Public Land Survey System in the United States) may be possible.

Once all the information about a bidder profile 172 is entered, the ‘Save Profile’ control may be selected to save the bidder profile 172.

### Creating a Land Listing

Referring to FIG. 5, shown there generally as 500 is a screenshot of an example user interface for creating a land listing, in accordance with at least one embodiment. As discussed above, this user interface may be provided by the land registration module 130 shown in FIG. 1 to allow a landowner (e.g., using a landowner device 104) to register a particular parcel of land as a land listing 152.

The user interface may be configured to receive a title 510 (e.g., ‘Jim's Route 8 Listing’), a legal land description 515 (e.g., ‘SW-3-13-22-W2’), and/or a number of farming acres 520 of the parcel of land for the land listing 152.

In some embodiments, the user interface may be configured to receive assessment reports, which may be issued or provided by independent agencies, companies or government bodies. The user interface may have the option to upload or attach such assessment reports by the party creating the land listing. Such assessment reports are discussed later in the description.

The user interface 500 may also be configured to provide a map 505 that shows the physical location of the parcel of land entered into the legal land description field 515. As noted above, to convert the legal land description into geographic coordinates that can be received by the mapping service 180 shown in FIG. 1, the land registration module 130 may be configured to transmit the legal land description to the GIS data service 182 so that the GIS data service can convert the legal land description to the geographic coordinates.

In various embodiments, the land registration module 130 may be configured to pre-populate the farmable acres field with a calculated size of the parcel of land identified by a given legal land description 515. However, the content of the farmable acres field 520 may be overridden by the landowner because the actual farmable acres may be smaller than the overall size of the parcel of land (e.g., due to bushes, trees, or other obstructions that reduce the amount of farmable land on the parcel of land).

The user interface 500 for creating a land listing 152 may also be provided with various fields and controls for receiving information about the parcel of land. For example, the user interface may have a section for receiving the previous year's inputs onto the parcel of land 525. Under this section, the user interface 500 may receive input indicating the types of chemicals 530 (e.g., ‘Round-up’) and their respective application amounts 535 in the previous year (‘1.5 litres per acre’). As well, the user interface 500 may receive input indicating the amount of fertilizer 550 (e.g., ‘Nitrogen’) and their respective application amounts 555 in the previous year (e.g., ‘110 pounds per acre’). The user interface may be provided with various controls 540, 560 that allow a landowner to add additional information about other types of chemicals and/or fertilizers inputs that they've applied to the given parcel of land in the previous year.

The user interface may also have a section for receiving the previous year's crop and yield 565. Under this section, the user interface 500 may receive input indicating the type of crop 570 the parcel of land has produced in the previous year (e.g., ‘Wheat’, ‘Canola’), and the yield of each type of crop 575 in a given year (e.g., ‘65 bushels of wheat in 2012’, and ‘45 bushels of Canola in 2011’).

In various embodiments, this information may be displayed when a potential bidder views details about a given auction for the created land listing 152.

### Creating a Land Auction

Referring to FIG. 6, shown there generally as 600 is a screenshot of an example user interface for creating an electronic auction, in accordance with at least one embodiment. After creating a land listing 152 using the land registration module 130 shown in FIG. 1, a landowner may be able to create an auction for, e.g., renting the parcel of land. The user interface 600 may, for example, be provided by the auction creation module 142 shown in FIG. 1.

The user interface 600 may be configured to receive a title 602 for the auction (e.g., ‘Jim's Route 8 Auction’). As well, the user interface 600 may have a section 604 indicating the parcels of land that are to be associated with the auction that is being created. Since, in the illustrated example, legal land descriptions according to land surveys are used to identify parcels of land available for auction, the user interface 600 may allow the selection of ‘quarter sections’ of land to be included in the auction. As will be understood, the term ‘quarter section’ refers to an area of land that is one-fourth of a square mile, and the term ‘quarter section’ is a common size of a tract of land used in the Dominion Land Survey in Canada and the Public Land Survey System in the United States.

As illustrated, the user interface 600 may provide options that allow the selection of an individual quarter section to be associated with the auction, or that allows the selection of multiple quarter sections be associated with a single auction. Once the option is picked, the user interface 606 may provide a user control 606 that allows the landowner to select the parcels of land that they have earlier registered as land listings 152. As illustrated, the landowner may have previously entered three land listings 152: ‘Jim's Route 8 Listing’, ‘Jim's Route 15 Listing’, and ‘Jim's Hwy 9 Listing’. The landowner may then be able to select, from this user control 606, the land listings 152 that he/she would like to associate with the auction. If the user has selected to only associate a single land listing 152 with the auction, the control 606 may be configured to only allow the selection of one land listing 152. If the user has selected to ‘Bundle your land’ (e.g., associate multiple quarter sections with the auction), the control 606 may be configured to allow the selection of multiple land listings 152.

Additionally, the user interface 600 may be provided with the option of setting the length of the auction 608 (e.g., ‘2 months’), and the start date 610 of the auction (e.g., ‘Mar. 14, 2014’).

As discussed above, in the land auction system of the present embodiments, the electronic auctions 162 may be set to be different types. Some examples of electronic auction types include: crop share type, cash rent type, make an offer type, pasture land type etc. In some embodiments, the user interface 600 provided to landowners for auction creation includes crop share and cash rent type auctions. In some other embodiments, the user interface 600 provided to landowners for auction creation include crop share, cash rent and make an offer type auctions. In some further embodiments, the user interface 600 provided to landowners for auction creation include crop share, cash rent and pasture land type auctions. Pasture land type auctions may be provided in addition to or as an alternative to make an offer type auctions. Other types of auctions in addition to or as an alternative to above-mentioned types of auctions may also be provided in the user interface 600.

The user interface 600 of FIG. 6 provides an example of a user interface offering the landowners the crop share 630, cash rent 640 and pasture land 650 type auctions.

In the crop share 630 auction type, the bid inputs may be for a portion of crops producible by the identified parcel of land. If this option is selected, the auction 162 may be configured to receive an opening bid that indicates an initial distribution of the crops between the landowner and the renter. As the auction 162 progresses, each successive bid input may increase the portion of the crops to be given to the landowner (or correspondingly, decrease the portion of crops taken by the potential renter). As illustrated, the division of the crops is represented as a percentage, and an opening bid of ‘35%’ for the landowner and ‘65%’ for the renter is shown. In the example, when an auction starts, the ‘current bid’ will start at ‘35%’, and when potential renters place a bid, they may be able to increase the percentage of the crops provided to the landowner (e.g., by entering ‘36%’, ‘37%’, and so forth). An example user interface for receiving this type of bid input is shown in FIG. 8, and will be discussed in greater detail below.

In the cash rent 640 auction type, the bid inputs may be configured to be in units of ‘dollars per acre’. The user interface 600 may receive input regarding a reserve price 642 that indicates a minimum amount that the landowner is willing to rent their parcel of land for. As discussed above with respect to the user interface shown in FIG. 3, in various embodiments, the auction 162 may be configured to not begin until the reserve price 642 is met. For the cash rent 640 auction type, the auction 162 may also be configured to have a ‘Rent Now At’ 644 price that allows potential renters to skip the auction process, and rent the parcel of land right away at the (typically higher) price indicated by rent now at 644 price.

In the pasture land 650 auction type, the landowner may indicate that the parcel of land they desire to rent out is to be used for grazing by farm animals. In some farming communities, the value of pasture land is established by the number of livestock that can be grazed on the parcel of land. As such, if the landowner is renting out a parcel of pasture land, they may select the ‘pasture land’ auction type 650 to allow the bid inputs for the auction to be received in units of a monetary value per each animal that can be grazed on the pasture land. As shown, the user interface 600 can receive input in the form of a dollar amount ‘per cow per day’ 652, with an opening bid of ‘one dollar per cow per day’. An example user interface for receiving this type of bid input is shown in FIG. 9, and will be discussed in greater detail below. Although the example user interface 600 shows units of ‘per cow per day’, it will be understood that the bid inputs may be established for different kinds of farm animals and different units of time (e.g., ‘per sheep per week’).

As previously mentioned, the user interface 600 may also include ‘make an offer’ type auction. Make an offer type auction provides the bidders with the flexibility of making a creative offer to the landowners to persuade the landowners to accept the bid. Such offers constitute new offers not already mentioned or provided to the potential bidders in the user interface 600. Examples of such offers may include an offer to use bidder's livestock in exchange for payment to the landowner, an offer to use bidder's farm equipment (such as tractors, grain trucks etc.) in exchange for payment to the landowner, an offer to use bidder's other farm properties in exchange for payment to the landowner etc. Make an offer type auctions provides an opportunity to the potential bidders to make creative and unique offers to the landowners in exchange for rental, purchase or lease payments.

In addition to the auction type 620, the user interface 600 may also be provided with an ‘Agreement’ section 660 that receives input relating to the terms of the rental agreement desired by the landowner. Landowners may not only be concerned with achieving the highest rental price for their parcel of land. For example, they may also be concerned that the renter will be a good steward of the parcel of land. When creating the auction for a given parcel of land, the user interface 600 may thus allow the landowner to set various conditions relating to the rental agreement between the landowner and the renter.

For example, the agreement section 660 may receive input about the desired length of the rental term (e.g., ‘3 years’). As well, the agreement section 660 may receive inputs about conditions that the landowner requires of the eventual renter of his/her parcel of land. As illustrated, the user interface 600 may allow the selection of suggested conditions 664 or the creation of customized conditions 680. An example of a suggested condition 664 may include requiring that the winning bidder be subject to the landowner's approval of a bidder's profile 670 (e.g., a ‘renter’ profile, as may be created by a bidder via the user interface shown in FIG. 4). Another example of a suggested condition includes the landowner requiring pre- and post-agronomic assessment 672 of the parcel of land (e.g., requiring an agronomic assessment before and after the duration of renter's farming presence on the land).

Additional or alternative to the suggested conditions 664, the user interface 600 may provide the option to receive customized conditions 680 that a landowner may wish to require of renters. An example of a customized condition 685 may be that the landowner requires the renter to ‘place 120 pounds of nitrogen on the land each year’ to ensure that the parcel of land stays fertile during the renter's time on the parcel of land. Once the customized condition 685 has been entered, they may add it to the auction by using the ‘add to auction’ control 687. In various embodiments, the user interface 600 may provide additional user controls for receiving additional customized conditions to be added to the auction.

After the various settings of the auction have been entered, the auction 162 may be created if the ‘create auction’ control 690 is selected. The created auction 162 may then be stored in the auction database 160 shown in FIG. 1.

Displaying a Home Quarter when Viewing Available Land Auctions

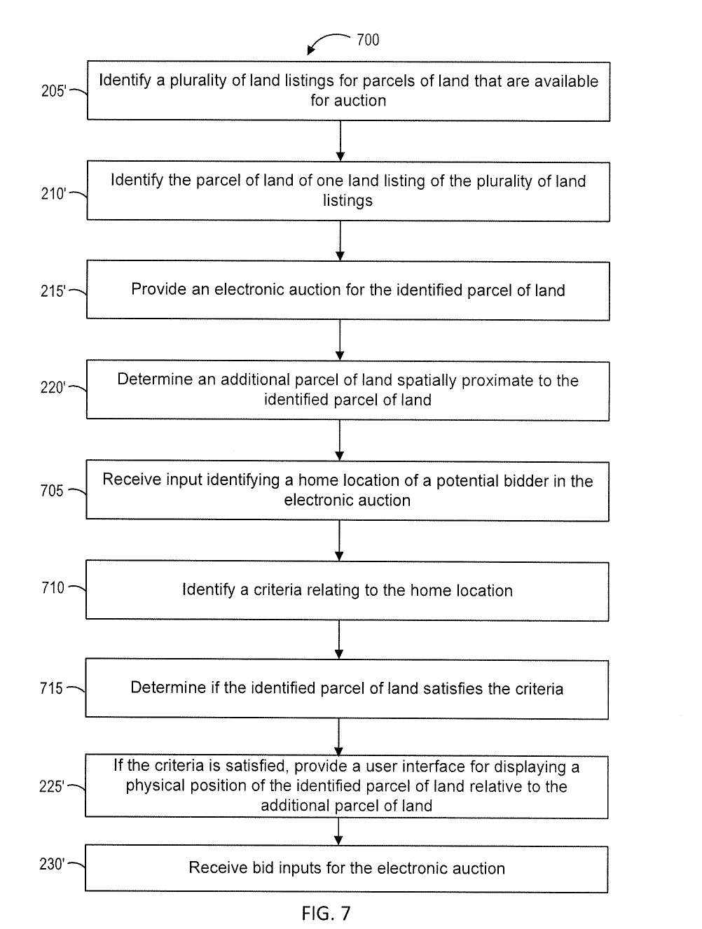

Referring to FIG. 7, shown there generally as 700 is a flowchart diagram illustrating the steps of a method of providing a land auction, in accordance with another example embodiment. The steps shown in FIG. 7 are similar to those shown in FIG. 2, except that prior to providing the user interface for displaying physical locations of identified parcels of land, additional steps 705-715 relating to a home location of a potential bidder are performed. When discussing the method of FIG. 7, reference will also simultaneously be made to various components shown in FIG. 1.

Steps 205′ to 220′ of FIG. 7 are generally analogous to steps 205 to 220 in FIG. 2, and may be performed in a similar manner. As discussed above, these steps may result in the identification of land listings 152 for parcels of land that are spatially proximate to each other. In various embodiments, any two given parcels of land may be considered to be sufficiently spatially proximate if the parcels of land can be shown together on a map in an ‘available auctions’ user interface (e.g., as is shown in FIG. 3).

At step 705, input may be received identifying a home location of a potential bidder in the electronic auction. For example, this step may have been performed when a bidder registers to use the auction server 102 for the first time. Additionally or alternatively, this step may have been performed when a bidder profile 172 is created. As discussed above, and referring briefly back to FIG. 4, the user interface 400 for creating a bidder profile 172 may be configured to receive a home location 410 for a given bidder.

At step 710, a criteria relating to the home location may be identified. This step may be performed, for example, by the bidding module 144 shown in FIG. 1, when a potential bidder attempts to locate available auctions. For example, in various embodiments, the criteria may be hard coded into the bidding module 144. Additionally or alternative, the criteria may be configurable in the user interface that displays available auctions. In various embodiments, the criteria relating to the home location may be a maximum acceptable distance from the home location.

At step 715, the bidding module 144 may determine if the identified parcel of land satisfies the criteria relating to the home location. For example, where the criteria is a maximum acceptable distance from the home location, this step may involve calculating the distance between the identified parcel of land and the home location. As discussed above, the home location may be entered as a legal land description according to the Dominion Land Survey. As such, to determine the distance between a given parcel of land and the home location, the bidding module 144 (as shown in FIG. 1) may communicate with the GIS data service 182 to convert the legal land description to geographic coordinates. These geographic coordinates can then be used with the geographic coordinates of the identified parcel of land to calculate the distance between the two physical locations, and thereby determine if such distance satisfies the maximum acceptable distance criteria.

At step 225′ and 230′ of FIG. 7, a user interface similar to that which was discussed above with respect to steps 225 and 230 in FIG. 2 may be displayed.

Referring to FIG. 8, shown there generally as 800 is a screenshot of an example user interface for viewing available land auctions, in accordance with other example embodiments. The user interface of FIG. 8 is similar to the user interface shown in FIG. 3 in that the relative physical locations of parcels of land associated with auctions 162 can be shown on a map 305. Additionally, the map 305 in FIG. 8 displays the home location 410 of a given potential bidder, along with a highlighted area 815 (as shown in dotted outline) surrounding the home location for the maximum acceptable distance criteria. As illustrated, the bidder may be able to easily determine that the three auctions 162 at the intersection of ‘Hwy 1’ and ‘Route 12’ satisfy the maximum acceptable distance criteria (e.g., are within the maximum acceptable distance), but that the auction 162 at the intersection of ‘Hwy 1’ and ‘Route 8’ and the auction at the intersection of ‘Hwy 9’ and ‘Route 12’ do not satisfy the maximum distance criteria (e.g., are outside the maximum acceptable distance).

By displaying whether a given land auction 162 satisfies a criteria with respect to the home location in the manner shown, a potential bidder may be better able to locate the land auctions 162 that he or she may be interested in. For example, the criteria may be a maximum acceptable distance criteria that is set to ‘20 kilometers’ from the home location of the bidder (e.g., because a potential renter would not want to travel more than ‘20 kilometers’ to farm parcels of land he/she rents). By indicating whether or not a given land auction 162 satisfies the criteria, a given bidder may be able to more easily locate land auctions 162 that are of interest to the bidder.

Similar to the user interface shown in FIG. 3, the user interface of FIG. 8 may be provided with an ‘Auction Details’ pane 350 that displays details about a selected auction 162 and receives bid inputs. As illustrated, the auction 162 at the intersection of ‘Hwy 1’ and ‘Route 8’ is selected (this is illustrated in FIG. 8 by the ‘X’ at that intersection being shown in bold and enlarged), and details about that auction 162 are displayed in the ‘Auction Details’ pane 350.

The ‘Auction Details’ pane 350 for the auction selected in the user interface of FIG. 8 indicates the name 355′ of the auction (e.g., ‘Jim's Route 8 Auction’), the end date 360′ for the auction (e.g., ‘May 15, 2014, 6:00 pm’), and the time remaining 365′ in the auction (e.g., ‘10 minutes’). In this illustrated example, however, the auction type 370′ is of a ‘Crop Share’ type (e.g., as may have been selected when the auction was created using the user interface shown in FIG. 6). As such, the current bid 875 is shown in units of a portion (e.g., a percentage) of the crops producible on the parcel of land, and the bid input control 880 is provided in a format that allows a bidder to input a value indicating a portion (e.g., a percentage) of the crops that they are willing to share with the landowner. The user interface may also be provided with a ‘Place Bid’ control 390′ that can be selected to place a bid.

Since, in the user interface of FIG. 8, the home location can be displayed on the map 305, the ‘Auction Details’ pane 350 may also be configured to display a distance 830 from the home location 410 (e.g., ‘40 km’). The ‘Auction Details’ pane 350 may also be configured to indicate whether or not the parcel of land associated with the selected auction 162 satisfies the criteria related to the home location (e.g., the parcel of land for the auction 162 not satisfying the criteria because it is ‘outside the maximum acceptable distance of 20 km’).

Moreover, the ‘Auction Details’ pane 350 may indicate various conditions that the landowner associated with the auction 162 when the auction was created. For example, the conditions may have been selected to be associated with the auction when the auction was created using the user interface shown in FIG. 6. An example condition requiring approval of a bidder profile 385′ (e.g., a ‘renter’ profile) is shown. As well, an additional condition requiring pre- and post-agronomic assessments 885 is also shown.

Referring to FIG. 9, shown there generally as 900 is a screenshot of an example user interface for viewing available land auctions, in accordance with another example embodiment. The screenshot of FIG. 9 is similar to the screenshot of FIG. 8 in that the map 305 shows the physical locations of auctions 162 on the map 305. The map 305 of FIG. 9 also shows the home location 410 and a highlighted area 815 (as shown in dotted outline) surrounding the home location for the criteria of the maximum acceptable distance from the home location.

In the user interface of FIG. 9, however, yet another auction 162 is selected in the map 305 (e.g., the rightmost auction 162 at the intersection of ‘Hwy 1’ and ‘Route 12’ is selected and the ‘X’ is shown in bold and enlarged). The ‘Auction Details’ pane 350 thus shows details about that selected auction such as the name 355″ (e.g., ‘Alan's Route 12 Auction’), the auction end date 360″ (e.g., ‘Apr. 15, 2015, 6:00 pm’), and the time remaining in the auction 365″ (e.g., ‘4 days’).

Since the map 305 in FIG. 9 shows the home location in a manner similar to FIG. 8, the ‘Auction Details’ pane 350 in FIG. 9 may also show the distance 830′ the parcel of land for the selected auction 162 is from the home location (e.g., ‘15 km’). As well, the ‘Auction Details’ pane 350 may also indicate that the distance from the home location satisfies a criteria related to the home location (e.g., that the parcel of land for the auction 162 is ‘within the acceptable maximum distance of 20 km’).

In the example shown, the selected auction type 370″ is of the ‘Pasture Land’ type. As discussed above with respect to FIG. 6, bid inputs for this type of auction may be based on a monetary value per each animal that can be grazed on the pasture land. As such, the current bid 975 indicated for this auction is ‘1.10 per cow per day’. The bid input control 980 may thus be provided in the same units. As illustrated, a potential renter may enter ‘1.25 per cow per day’ as their bid, and select the ‘Place Bid’ control 390 to place their bid.

As shown, the selected auction 162 being shown in the ‘Auction Details’ pane 350 in FIG. 9 may have a large number of conditions associated with it. As such, instead of explicitly stating the conditions on the ‘Auction Details’ pane 350, the ‘Auction Details’ pane 350 may provide a link 985 that, when selected, displays to the potential renter the various conditions associated with the auction 162.

While not explicitly indicated in the user interfaces of FIGS. 3, 8, and 9, it will be understood that additional information may be displayed when an auction 162 is selected for viewing. For example, this information may include information about the parcel of land to be rented out such as crop yield information, crop input information, soil class, and/or a land assessment value. In some embodiments, the user interfaces of FIGS. 3, 8 and 9 may include assessment reports, which may be issued or provided by independent agencies, companies or government bodies. An example of such an assessment report is SAMA (Saskatchewan Assessment Management Agency) report. SAMA report typically includes land/property specific information, such as, assessed value of the land, taxable value of the land, size of the land, status of land use, productivity determining factors for the land, economic and physical factors for the land, and land rating etc. Such assessment reports include above-listed and other land specific information to allow the potential renters, purchasers, or lessees to make informed decisions regarding renting, purchasing or leasing the land. As discussed, some of this information may have been entered via the user interface shown in FIG. 5.

In various embodiments, the systems and methods for conducting electronic land auctions use push notification technology. In such embodiments, the auction server comprises push servers configured to send notifications to the bidder and/or landowner devices upon completion of one or more events. Some examples of such events include receipt of new bids by landowners, a new listing of land or property, a completed sale, lease or rent transaction etc. Auction server may be configured to push notifications via e-mail and/or social media platforms, such as Facebook®, Twitter®, and LinkedIn® etc.

In one example, the auction server is configured to push notifications to the bidder if the bidder's bid is accepted by a landowner. In another example, the auction server is configured to push notification to the landowner if a new bid has been received on a property or land listed by the landowner. Auction server may be configured to detect other events, upon completion of which push notifications are sent to bidder and/or landowner devices.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

For example, the steps of a method in accordance with any of the embodiments described herein may be performed in any order, whether or not such steps are described in the claims, figures or otherwise in any sequential numbered or lettered manner. Also, in the various user interfaces illustrated in the figures, it will be understood that the illustrated user interface text and controls are provided as examples only and are not meant to be limiting. Other suitable user interface elements may be possible.

As used herein, the wording “and/or” is intended to represent an inclusive-or. That is, “X and/or Y” is intended to mean X or Y or both. Moreover, “X, Y, and/or Z” is intended to mean X or Y or Z or any combination thereof.

1. A method of conducting an electronic auction, the method comprising:
identifying a plurality of land listings, each of the plurality of land listings corresponding to a parcel of land that is available for auction;
identifying the parcel of land of one land listing of the plurality of land listings;
providing an electronic auction for the identified parcel of land;
determining, using one or more of the plurality of land listings, an additional parcel of land that is available for auction, the additional parcel of land being spatially proximate to the identified parcel of land; and
providing a user interface for
displaying the identified parcel of land,
displaying a physical position of the identified parcel of land relative to the additional parcel of land, and
receiving bid inputs for the electronic auction.

2. The method of claim 1, wherein the user interface is configured for:
displaying the additional parcel of land.

3. The method of claim 1, wherein the user interface comprises a map that displays the physical position of the identified parcel of land relative to the additional parcel of land.

4. The method of claim 3, wherein the map displays the identified parcel of land as being adjacent to the additional parcel of land.

5. The method of claim 1, further comprising:
determining a plurality of additional parcels of land that are available for auction, each of the plurality of additional parcels of land being spatially proximate to the identified parcel of land; and
wherein the user interface displays the physical position of the identified parcel of land relative to each of the plurality of additional parcels of land.

6. The method of claim 5, wherein the plurality of additional parcels of land are connected to each other, and the identified parcel of land completes a block of land that includes the identified parcel of land and the plurality of additional parcels of land.

7. The method of claim 1, wherein at least one of the plurality of land listings comprise Geographical Information Systems (GIS) data.

8. The method of claim 1, wherein the user interface is configured to display, for the identified parcel of land, data selected from a group consisting of: crop input information, a soil class, a land assessment report, and a legal land description.

9. The method of claim 1, wherein the identified parcel of land is identifiable using a land identifier from a land survey.

10. The method of claim 1, wherein the electronic auction is associated with conditions governing use of the identified parcel of land.

11. The method of claim 1, wherein prior to displaying the identified parcel of land, the user interface is further configured for receiving input identifying a home location of a potential bidder in the electronic auction, and receiving input indicating a criteria relating to the home location; and wherein the identified parcel of land satisfies the criteria.

12. The method of claim 11, wherein the criteria comprises a maximum acceptable distance from the home location.

13. The method of claim 1, wherein the electronic auction is not initiated until a reserve price for the identified parcel of land is reached.

14. The method of claim 13, wherein after the electronic auction is initiated, the electronic auction is set to end after a predetermined period of time.

15. The method of claim 1, wherein the electronic auction does not end until a period of time after a final bid is made.

16. The method of claim 1, wherein the bid inputs for the electronic auction comprise a portion of crops producible by the identified parcel of land.

17. The method of claim 1, wherein the identified parcel of land comprises pasture land, and the bid inputs comprise a value per each animal that can be grazed on the pasture land.

18. A server device comprising a processor and a memory storing instructions which, when executed by the processor, cause the processor to perform the method of claim 1.

19. A computer readable medium storing instructions which, when executed by a processor of a computing device, cause the processor to perform the method of claim 1.
